(19) United States
(12) Patent Application Publication
(10) Pub. No.: US 2024/0330752 A1
(43) Pub. Date: Oct. 3, 2024

(54) SYSTEM AND METHOD FOR MANAGEMENT OF INFERENCE MODELS THROUGH REVERSION

(71) Applicant: Dell Products L.P., Round Rock, TX (US)

(72) Inventors: OFIR EZRIELEV, Be'er Sheva (IL); TOMER KUSHNIR, Omer (IL); AMIHAI SAVIR, Newton, MA (US)

(21) Appl. No.: 18/193,805

(22) Filed: Mar. 31, 2023

(51) Int. Cl. G06N 20/00

(52) U.S. Cl. CPC G06N 20/00

(57) ABSTRACT

Methods and systems for managing inference models are disclosed. The inference models may be used to provide computer implemented services by generating inferences used in the services. The inference models may be managed by reverting inference models that are found to be compromised through training with poisoned training data. The type of reversion to be performed may be selected based on the cost for performing the reversion and benefits provided by the reverted inference model.

### FIELD

Embodiments disclosed herein relate generally to inference model management. More particularly, embodiments disclosed herein relate to systems and methods to manage inference model management through reversion.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a diagram illustrating data flows in accordance with an embodiment.

FIGS. 2B-2D show diagrams illustrating a graphical user interface in accordance with an embodiment.

FIGS. 3A-3B show flow diagrams illustrating methods of managing inference models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing inference models. The inference models may be used to provide computer implemented services. Inferences generated by the inference models may be used during performance of the computer implemented services.

Over time the inference models may be updated. However, updating the inference models may result in the inference models generated undesirable inferences. For example, poisoned training data that may taint the inference models may be inadvertently used during the model update process.

To manage the tainted inference models, reversions may be performed to reduce or eliminate an influence of the poisoned training data on the inferences generated by the inference models. However, the resource cost for performing reversions may be significant.

To manage reversion of inference models, a graphical user interface may be presented to a user. The user may explore options for performing different types of reversions, and ascertain the resource cost for the different types of reversions. By allowing the user to explore the tradeoffs associated with the different reversions, the user may be better able to select the type of reversion to perform while managing an impact of the consumption of resources for performing the reversion.

Once a user selects the type of reversion to perform, the reversion may be performed. The resulting updated inference model may be partially or substantially completely free of the influence of the poisoned training data on inferences produced by the updated inference model, depending on the type of reversion selected by the user.

By doing so, embodiments disclosed herein may improve the likelihood that inference obtained using inference models are desirable. A system may do so by proactively identifying costs for performing different types of reversions, and allowing the user to explore the different operations for performing reversions. Thus, embodiments disclosed herein may provide a system that reduces the cognitive burden on users for management of the system. By enabling the user to explore the likely costs and benefits of different types of reversions, reversion that are better aligned with the computing resource availability of the system may be selected. Consequently, the system may be less likely to experience slowdowns due to lack of computing resources.

In an embodiment, a method for managing inference models is disclosed. The method may include identifying an inference model of the inference models that is compromised; identifying a first resource cost for reverting the inference model to an uncompromised state and second resource cost for reverting the inference model to a partially compromised state; obtaining a reversion plan for the inference model using a graphical user interface based at least in part on the first resource cost and the second resource cost; performing the reversion plan to obtain an updated inference model; and using the updated inference model to provide computer implemented services.

Obtaining the reversion plan may include presenting, to a user, the graphical user interface including: a range bar, a model indicator positioned with the range bar, a first recovery point positioned with the range bar, and a second recovery point positioned with the range bar; and obtaining, from the user and to define the reversion plan, user input indicating a selection of the first recover point or the second recovery point.

The first recovery point may be based on a first previous version of the inference model in the uncompromised state, and the second recovery point may be based on a second previous version of the inference model in the compromised state.

The first recovery point and the second recovery point may be positioned with the range bar based on a temporal ordering the first previous version of the inference model, the second previous version of the inference model, and the inference model.

The second previous version of the inference model may be a further trained version of the first previous of the inference model based on a first portion of poisoned training data.

The inference model may be a further trained version of the second previous of the inference model based on a second portion of poisoned training data.

The graphical user interface may also include a compromise indicator positioned with the range bar, the compromise indicator being based on the first portion of the poisoned training data and the second portion of the poisoned training data.

The graphical user interface may further include a reversion cost estimate indicator that indicates a computing resource cost for reverting the inference model to previous versions of the inference model based on the user input; and a reversion time estimate indicator that indicates a duration of time for reverting the inference model to the previous versions of the inference model based on the user input.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

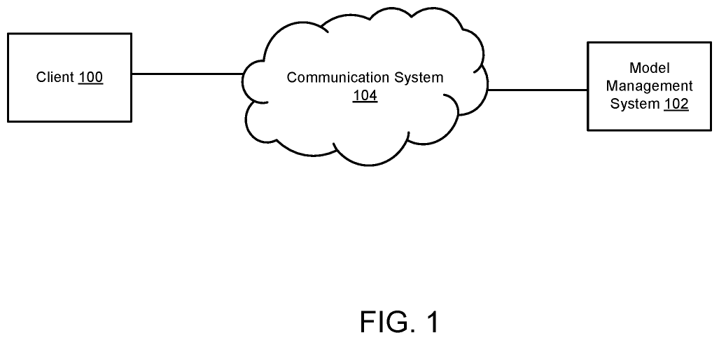

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

The computer implemented services may be provided at least in part using inference models. The inference models may be implemented using machine learning models such as neural networks, decision trees, support vector machines, clustering, and/or other types of learning models.

The inference models may be obtained by (i) obtaining training data (labeled and/or unlabeled) that reflects relationships for which inferences are to be generated, and (ii) generating trained inference models using the training data. Once obtained, the inference models may generate inferences as output for ingest data (e.g., which may include any number and types of features).

Overtime, additional training data may be obtained. The operation of the inference models may be updated using the additional training data. The inferences generated by the updated inference models may reflect the additional information included in the additional training data.

However, updates to inference models may, over time, modify the inference models in undesirable manners. For example, a malicious entity may attempt to inject malicious training data (e.g., poisoned training data) into the update process. If used to update the operation of the inference models, the resulting updated inference models may generate undesired inferences.

If the undesired inferences are used to provide computer implemented services, then the computer implemented services may be undesirable. For example, consider a scenario where an inference model provides inferences regarding future prices of a commodity based on current production information for the commodity. A malicious party may attempt to inject malicious training data into update processes that cause the updated inference models to generate inferences for the future price that may be exploited by the malicious party. A business may use the inferences to drive an automated purchasing process (e.g., a computer implemented service) which, if driven using the inferences from the updated inference model, may be exploited by the malicious party to profit on the automated purchasing process.

In general, embodiments disclosed herein may provide methods, systems, and/or devices for managing inference models. The disclosed systems may manage inference models in a manner that allows for the impacts of poisoned training data used to update inference models to be remediated.

To remediate the impact of poisoned training data, the disclosed systems may (i) retain information regarding updates made to inference models that allow the inference models to be reverted to remove some or all of the influence of the poisoned training data, (ii) estimate the resource cost (e.g., computational resource cost, financial cost, etc.) for performing different types of reversions (e.g., complete reversions to remove all of the influence of the poisoned training data or partial reversions to remove the influence of a portion of the poisoned training data on the model), (iii) present, via a graphical user interface, the different types of reversions and associated costs to a user such that the user may explore and understand the different costs involved in the reversions, (iv) obtain via the graphical user interface, user input indicating the type of reversion to perform, and (v) orchestrate performance of the type of reversion indicated by the user input. By doing so, embodiments disclosed herein may manage the impact of poisoned training data on operation of inference models while managing the cognitive burden on a user for managing the inference models. Through the use of the graphical user interface, the cognitive burden on the user may be reduced by allowing the likely costs involved with various reversions to be explored by the user. Thus, the burden for making the selection may reduce the amount of information which the user may need to be able to estimate correctly may be reduced.

To provide the above noted functionality, the system of FIG. 1 may include client 100 and model management system 102. Each of these components is discussed below.

Client 100 may provide and/or use computer implemented services. The computer implemented services may utilize inference models, as discussed above. For example, client 100 may host inference models that generate inferences used to provide computer implemented services, may use computer implemented services provided by other entities that utilize inference models, etc.

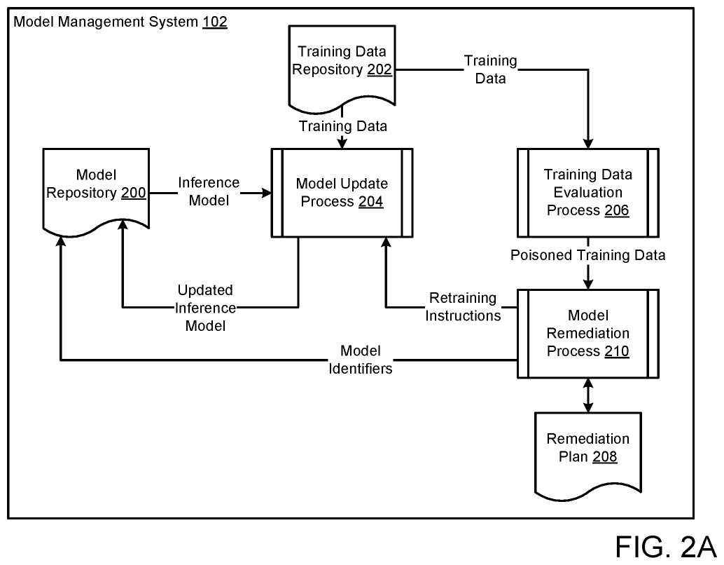

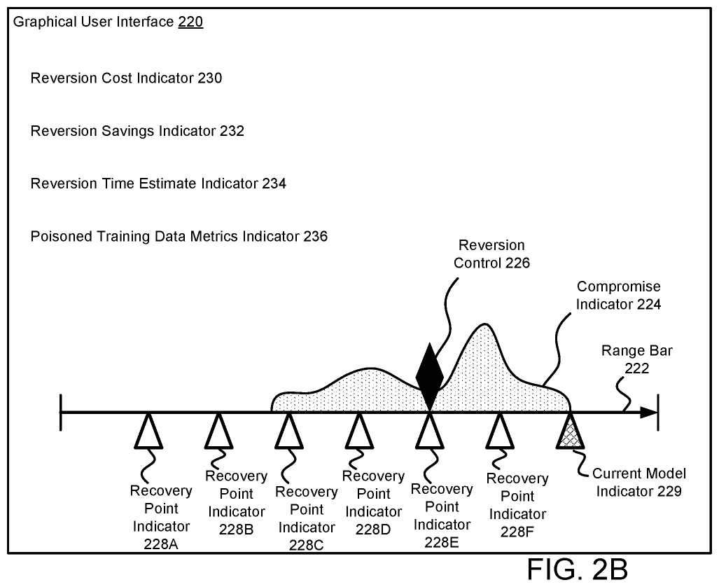

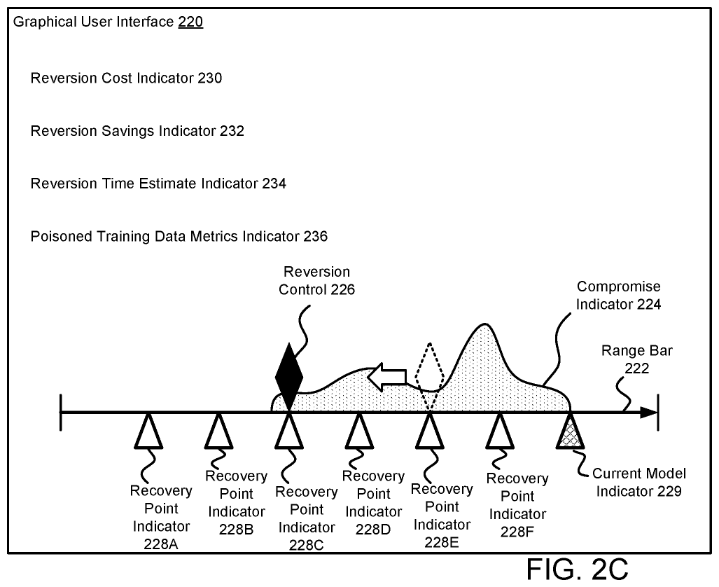

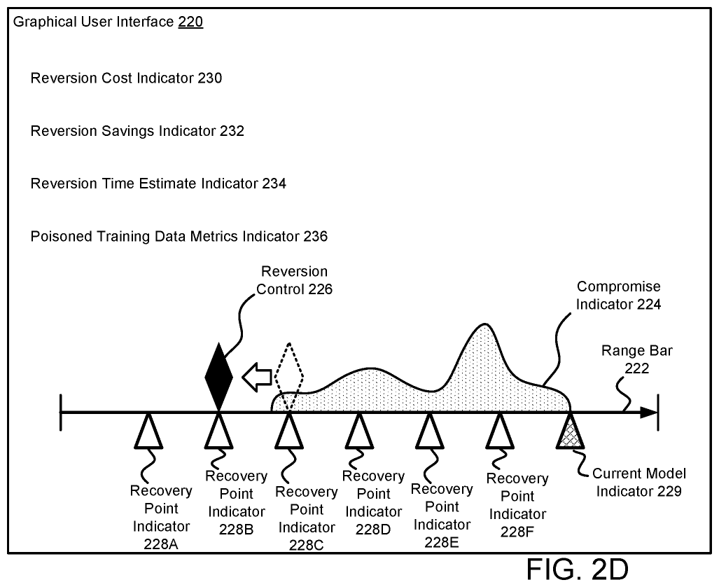

Model management system 102 may manage inference models. To manage the inference models, model management system 102 may (i) obtain the inference models, (ii) update the inference models, (iii) identify when inference models are likely impacted by poisoned training data, (iv) interact with a user via the graphical user interface to identify reversions to be performed for the impacted inference models, and (v) orchestrate performance of the identified reversions for the inference models. Refer to FIG. 2A for additional details regarding evaluation and management of inference models.

To identify reversions to be performed, model management system 102 may provide information (e.g., estimated resource costs) regarding potential reversions to a user and obtain user input indicating reversions to be performed. The information may be provided and user input may be collected using a graphical user interface. Refer to FIGS. 2B-2D for additional details regarding graphical user interfaces.

By managing inference models as disclosed herein, a system in accordance with embodiments may be more likely to provide desired computer implemented services. The computer implemented services may be more likely to be desired because the inferences used in providing the computer implemented services may be more likely to be accurate or meet expectations for use in the computer implemented services. The inferences may be more likely to be accurate or meet expectations through reversion of inference models that are likely to provide undesired inferences (e.g., by having been updated using poisoned training data).

However, due to the resource costs (and/or other factors such as time for reversion) involved in selecting how models are to be reverted, selection of reversions that appropriately balance the resource cost against benefits obtained by performing the reversions may be challenging to identify. Through use of a graphical user interface, the cognitive burden for balancing the cost and benefit may be reduced. By doing so, the disclosed system may be less likely to needlessly consume resources that provide an undesirably low level of benefit for inference generation. Thus, embodiments disclosed herein may address, among others, the technical problem of limited available computing resources in a distributed system. The disclosed embodiments may address the lack of computing resources by more efficiently marshaling limited computing resources for providing computer implemented services by improving the ratio of benefits obtained through model reversion against the resource cost for performing the reversions.

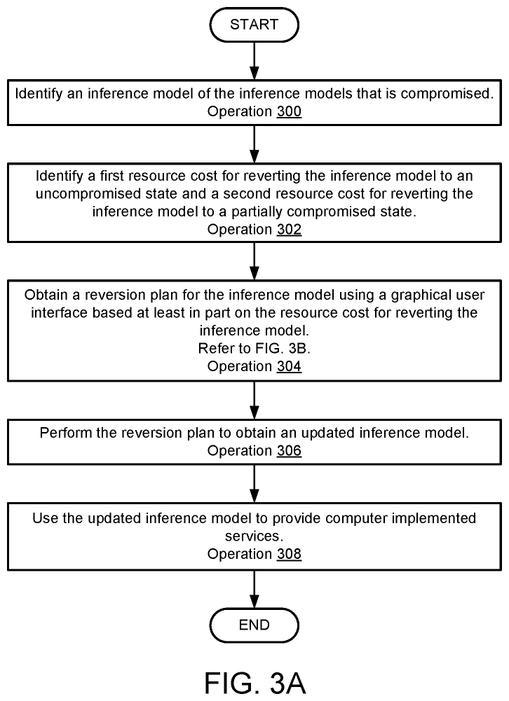

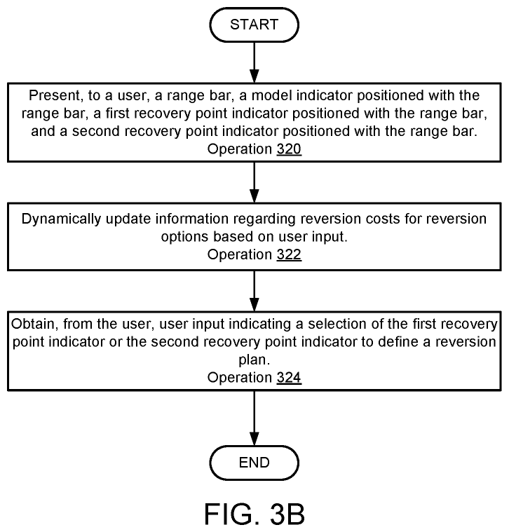

When providing their functionality, any of client 100 and model management system 102 may perform all, or a portion, of the methods illustrated in FIGS. 3A-3B.

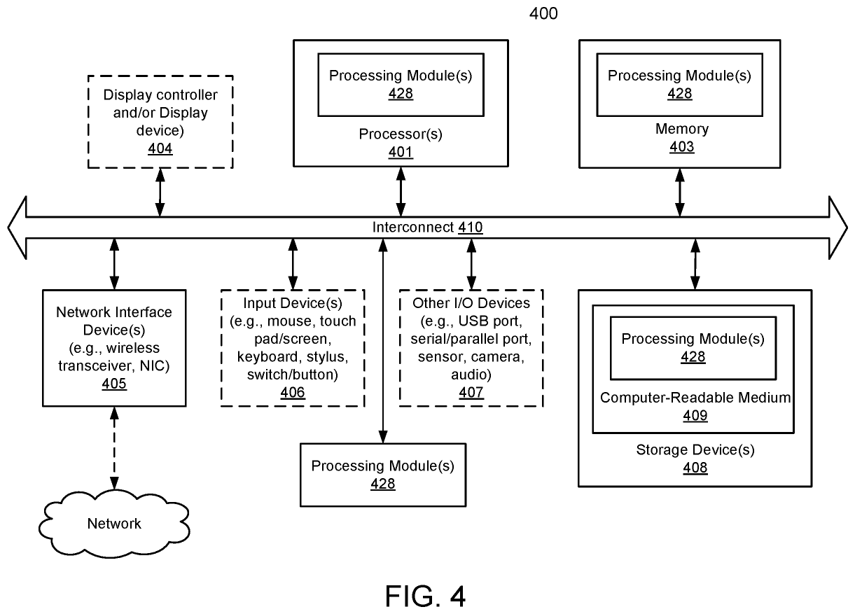

Any of client 100 and model management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Model management system 102 may be implemented with multiple computing devices. For example, model management system 102 may be implemented with a data center, cloud installation, or other type of computing environment.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein. For example, a system may include any number of instances of client 100, model management system 102, and/or other components not shown in FIG. 1. Any of the instances may perform similar and/or different functions.

To further clarify embodiments disclosed herein, a diagram illustrating data flows implemented by and data structures used by a system over time in accordance with an embodiment is shown in FIG. 2A.

Turning to FIG. 2A, a first data flow diagram illustrating data flows, data processing, and/or other operations that may be performed by the system of FIG. 1 in accordance with an embodiment is shown.

To facilitate computer implemented services using inferences, model management system 102 may (i) maintain, (ii) update, (iii) evaluate, and (iv) retain or revert inference models used by the system of FIG. 1.

To maintain inference models, model management system 102 may include model repository 200. Any number of inference models may be stored in model repository 200. As inference models are updated over time, samples of the inference models (e.g., that are deprecated) or information usable to revert inference models to previous versions may be retained in model repository 200. Additionally, information regarding the training data on which the inference models are based may be maintained in model repository 200. Further, information regarding inferences generated by the inference models may be stored in model repository 200. Accordingly, if an inference model is updated and the inference model is subsequently identified as having been poisoned due to poisoned training data used in its updating, (i) the inference model may be reverted to a previous state (e.g., which may be free of all or some of the influence of the poisoned training data), (ii) inference impacted by the poisoned inference model may be identified, and (iii) the poisoned training data upon which the poisoned inference model is based may be identified.

To update inference models, model management system 102 may include training data repository 202. Training data repository 202 may include any type and quantity of training data. As new training data becomes available, the new training data may be added to the repository. The training data may be used to (i) train new inference models, (ii) update inference models, and/or (iii) revert inference models (e.g., through untraining processes).

For example, when new training data becomes available, a corresponding inference model and the new training data may be retrieved from the respective repositories 200, 202. Model update process 204 may use the new training data to update weights or other characteristics of the inference model to obtain an updated inference model.

However, as discussed above, some training data may be malicious in nature, may include relationships that if used for training purposes may result in undesired inferences (e.g., such as exhibiting latent bias), and/or may otherwise have undesirable impacts on the inference model during training. For example, the updated inference model may generate inferences that are inaccurate, exhibit latent bias, or may be undesirable for other reasons.

To manage risk associated with updating of inference models (and/or during generation of new inference models), the training data in training data repository 202 may be subjected to training data evaluation process 206. During training data evaluation process 206, various evaluation processes may be performed to identify whether any of the training data is likely poisoned. The evaluation processes may include analysis processes (e.g., looking for inconsistencies, statistical aberration, etc.) of the training data itself, sources of the training data, etc. As new information regarding training data becomes available, the training data in training data repository 202 may be analyzed via training data evaluation process 206. Consequently, poisoned training data may be identified after inference models are updated using the poisoned training data and used to generate inferences. Further, some inference models that are already influenced by the poisoned training data may be further updated with additional poisoned training data or training data that is not poisoned. Thus, any number of updated inference models that are influenced by poisoned training data may be obtained and used prior to the poisoned training data being identified.

When poisoned training data is identified, the poisoned training data may be used to drive model remediation process 210. During model remediation process 210, (i) information regarding options for reverting a poisoned inference model may be presented to a user, (ii) the user may explore the options to select one of the operations for performance, and (iii) once selected, the selected option for reverting the poisoned inference models may be performed. To perform the selected reversion, stored previous versions of inference models may be utilized or retaining processes may be performed.

If previous versions of an inference model are available, then model identifiers may be provided to model repository 200. The model identifiers may be used to (i) identify a previous version of an inference model to be used as the most current version going forward, and (ii) identify other versions of the inference model that are poisoned and to no longer to be used (e.g., deprecated, deleted, etc.).

If retaining processes are to be performed, retraining instructions may be provided to model update process 204. The retaining instructions may indicate (i) an inference model from model repository 200 to be updated, (ii) training data from training data repository 202 to be used during retraining, and (iii) a retraining process to be performed. The retraining process may be an untraining process where the poisoned inference model is trained in a manner to remove the impacts of the training data (e.g., poisoned training data) identified by the retraining instructions. The resulting updated inference model may be free (or substantially free) of the influence of the training data used in the untraining.

However, the resource cost (e.g., computational, time, financial, etc.) for performing the untraining may depend on the quantity and distribution over time of adversarial data (e.g., poisoned training data injected into the training process) on which the model was trained. To balance the benefit of updating the inference model against the resource cost for the updating, information regarding the respective options for untraining may be presented to a user via a graphical user interface, and information usable to define remediation plan 208 may be obtained via the graphical user interface. Refer to FIGS. 2B-2C for additional details regarding graphical user interfaces.

Remediation plan 208 may include any amount of information regarding a process for reverting a poisoned inference model. As noted above, the content of remediation plan 208 may be obtained via a graphical user interface. The content of remediation plan 208 may indicate the model identifiers for reverting inference models and the retraining instructions for reverting inference models.

Once an updated inference model is obtained through reversion of a poisoned inference model, the updated inference model may be stored in model repository 200 and the corresponding poisoned inference models may be deprecated, deleted, and/or otherwise prevented from being used for inference generation purposes.

In an embodiment, model management system 102 is implemented using a hardware device including circuitry. The hardware device may be, for example, a digital signal processor, a field programmable gate array, or an application specific integrated circuit. The circuitry may be adapted to cause the hardware device to perform the functionality of model management system 102 as discussed herein. Model management system 102 may be implemented using other types of hardware devices without departing embodiment disclosed herein.

In an embodiment, model management system 102 is implemented using a processor adapted to execute computing code stored on a persistent storage that when executed by the processor performs the functionality of model management system 102 discussed throughout this application. The processor may be a hardware processor including circuitry such as, for example, a central processing unit, a processing core, or a microcontroller. The processor may be other types of hardware devices for processing information without departing embodiment disclosed herein.

In an embodiment, model management system 102 includes storage which may be implemented using physical devices that provide data storage services (e.g., storing data and providing copies of previously stored data). The devices that provide data storage services may include hardware devices and/or logical devices. For example, storage may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage may include a memory device (e.g., a dual in line memory device) in which data is stored and from which copies of previously stored data are provided. In another example, storage may include a persistent storage device (e.g., a solid-state disk drive) in which data is stored and from which copies of previously stored data is provided. In a still further example, storage may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

Storage may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage may store any of the data structures including remediation plan 208 discussed herein. Any of the data structures may be implemented using, for example, lists, tables databases, linked lists, unstructured data, and/or other types of data structures.

Turning to FIG. 2B, a first diagram of graphical user interface 220 in accordance with an embodiments is shown. Graphical user interface 220 may be used to (i) provide a user with information regarding options for reverting inference models and (ii) obtain user input indicating how an inference model is to be reverted. The user input may be used to establish a remediation plan (e.g., 208) for an inference model. Graphical user interface 220 may be presented to the user via a display (e.g., through a data processing system used by the person).

To provide the user with information regarding options for reverting an inference model, graphical user interface 220 may include range bar 222, compromise indicator 224, reversion control 226, recovery point indicators 228A-228F, current model indicator 229, reversion cost indicator 230, reversion savings indicator 232, reversion time estimate indicator 234, and poisoned training data metrics indicator 236. Each of these components of graphical user interface 220 is discussed below.

A range bar 222 may be implemented using one or more graphical elements along which other indicators (e.g., 224-229) may be positioned. Range bar 222 may be implemented using a line having a length. The positioning of these other indicators along range bar may indicate an ordering among the other indicators.

Compromise indicator 224 may be implemented using one or more graphical elements indicating quantities of poisoned training data on which various inference models are based. Compromise indicator 224 may be implemented using a filled area positioned along range bar 222. The filled area may represent the quantity of poisoned training data that was obtained over time and used to update an inference model over time. For example, a height of the filled are with respect to range bar 222 may indicate the relative quantities of poisoned training data obtained over time that was used to update versions of an inference model. Thus, a user may intuitively understand the relative quantity of poisoned training data on which each version of the inference model is based.

Reversion control 226 may be implemented using one or more graphical elements that may be manipulated by a user. For example, reversion control 226 may be positioned along range bar 222, and a user may provide slide reversion control 226 along range bar 222 to align with any of recovery point indicator 222A-222F. The user may position reversion control 226 with a recovery point indicator to (i) obtain information regarding resource costs for performing a reversion associated with the recovery point and (ii) select the reversion associated with the recovery point for performance. Refer to FIGS. 2C-2D for additional details regarding manipulation of reversion control 226.

Recovery point indicators 228A-222F may be implemented using one or more graphical elements, which may represent versions of the inference model to which a current version of the inference model may be reverted. The graphical elements may be positioned along range bar 222 in an ordering corresponding to relationships between the versions of the inference model. For example, the versions of the inference model may be related to one another by virtue of updates made to the inference model over time. The graphical elements for these versions may be ordered from oldest (e.g., to the left) to the most current (e.g., to the right).

When reversion control 226 is positioned with one of recovery point indicators 228A-228F, indicators 230-236 may automatically update to display corresponding information. Thus, a user may reposition reversion control 226 to identify how different options for reversions may impact resource expenditures for reversion, duration of time to complete the reversion, etc.

Current model indicator 229 may be implemented using one or more graphical elements, which may represent the current versions of the inference model. The graphical elements may be positioned along range bar 222 in an ordering with respect to the recovery point indicators corresponding to a relationship between the versions of the inference model and the current version of the inference model. For example, the versions of the inference model may be related to one another by virtue of updates made to the inference model over time, and the current model indicator 229 may be associated with the up-to-date model.

To facilitate exploration of the options for reversion associated with each of recovery point indicators 228A-228F, graphical user interface 220 may include indicators 230-236. These indicators may be dynamically updated as reversion control 226 is moved between different recovery point indicators. Any of indicators 230-236 may be implemented using one or more graphical elements, which may include text and/or other visual elements to communicate information to a user a graphical user interface 220.

Reversion cost indicator 230 may convey information regarding costs for performing a reversion. The cost may include computing resource costs (e.g., such as processor time, memory space, storage space, etc.) for performing the reversion. The cost may also include financial costs such as a cost for utilizing on-demand computing resources for performing the reversion (e.g., such as use of public cloud infrastructure with per use fees). Reversion cost indicator 230 may convey information regarding other types of costs without departing from embodiments disclosed herein.

The cost information may be obtained by, for example, analyzing the type and quantity of computations, quantity of training data involved in, and/or other factors which may contribute to costs for performing the reversions.

Reversion savings indicator 232 may convey information regarding savings for performing a partial reversion rather than a complete reversion. For example, if any of recovery point indicators 228C-228F are selected, the reverted model may still include some influence of poisoned training data because the model may not have been reverted to remove the influence of all of the poisoned training data (e.g., may need to revert to recovery point indicators 228B or earlier, in this example). The savings may be expressed, for example, by calculating a ratio of poisoned training data for which the influence is removed versus the total quantity of poisoned training data influence the inference model. The ratio and/or information based on the ratio may indicate to the user the relative quantity of poisoned training data that will still influence the inference model after reversion.

Reversion time estimate indicator 234 may convey information regarding an estimated duration of time for performing the reversion. The information may be estimated, for example, based on the computing resources expected to be expended to complete the reversion.

Poisoned training data metrics indicator 236 may convey information regarding a resource cost saved by performing a partial reversion of the model. The information may be estimated, for example, based on the computing resources expected to be expended to complete the partial reversion versus the computing resources expected to be expended to complete a full reversion (e.g., to remove all influence of the poisoned training data).

Turning to FIG. 2C, a second diagram of graphical user interface 220 in accordance with an embodiments is shown.

To use graphical user interface 220 to select a reversion for an inference model, the user may move reversion control 226 along range bar 222 (may be able to slide along to range bar 222 between discrete positions associated with recovery point indicators 228A-228F). In FIG. 2C, this movement is indicated by the oversized arrow and the retained dashed outline of the reversion control positioned proximate to recovery point indicator 228E. For example, as seen in FIG. 2C, reversion control 226 may slide from being proximate to recovery point indicator 228E to being proximate to recovery point indicator 228C.

While reversion control 226 is moved, indicators 230-236 may be dynamically updated. In this example, reversion cost indicator 230 may indicate that the resource cost for performing a reversion using the poisoned training data introduced into the inference model between recovery point indicator 228C and recovery point indicator 228E may increase due to the increased quantity of poisoned training data for which its influence on the inference model may be removed. For example, to revert the inference model to the state associated with recovery point indicator 228C, the majority of the poisoned training data may need to be used for untraining. Thus, while a partial reversion may be performed, the resource cost for doing so may be greater when compared to performing a reversion to the state associated with recovery point indicator 228E.

Turning to FIG. 2D, a third diagram of graphical user interface 220 in accordance with an embodiments is shown.

Continuing with the discussion from FIG. 2C, if a user determines, based on the information conveyed by indicators 230-236, that even this partial reversion shown in FIG. 2C is insufficient, the user may explore options for performing a full reversion. To do so, the user may use graphical user interface 220 to select a reversion for the inference model by moving reversion control 226 along range bar 222 (may be able to slide along to range bar 222 between discrete positions associated with recovery point indicators 228A-228F) until positioned proximate to recovery point indicators 228B or other inference models not indicated by compromise indicator 224 as being influenced by poisoned training data. In FIG. 2D, this movement is indicated by the oversized arrow and the retained dashed outline of the reversion control positioned proximate to recovery point indicator 228C.

Once reversion control 226 is moved, indicators 230-236 may be dynamically updated. In this example, reversion cost indicator 230 may indicate that the resource cost for performing a reversion using the poisoned training data introduced into the inference model between recovery point indicator 228B and current model indicator 229 may be increased (e.g., when compared to the previously discussed partial reversion), but may be acceptable.

The user may then instruct the selected reversion associated with recovery point indicator 228 to be performed. When selected, model management system 102 may establish remediation plan 208. To do so, information regarding the poisoned training data that influences the inference model may be added to remediation plan 208, as well as information regarding the current version of the inference model. The resulting remediation plan may be usable to drive model update process 204 to obtain an updated inference model that has been reverted from the current version of the inference model through untraining using the training data.

The untraining process may include, for example, (i) dividing the inference model into multiple portions (e.g., placing some layers of neurons on one side of the divide to establish a body and other layers of neurons on the other side of the divide near and output layer to establish a head), (ii) twinning the head, (iii) sequentially (a) training the body and head to reflect the relationships included in unpoisoned training data, and (b) untraining the body and the twined head (e.g., performing a gradient ascent rather than gradient descent optimization) to reduce the predictive ability of the body with respect to the poisoned training data, and (iv) once the body and head lack the ability to predict the relationships defined by the selected poisoned training data (to a predetermined level of lack of predictive ability), establishing an inference model using the body and the head.

Once reverted, the reverted inference model may be used to provide computer implemented services and may be further updated overtime as new training data becomes available.

As discussed above, the components of FIG. 1 may perform various methods to manage inference models used to provide computer implemented services. FIGS. 3A-3B illustrate methods that may be performed by the components of the system of FIG. 1. In the diagram discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method for providing computer implemented services using inference models in accordance with an embodiment is shown. The method may be performed by any of client 100, model management system 102, and/or other components of the system shown in FIG. 1.

Prior to operation 300, training data may be obtained and used to train one or more inference models. Additionally, as further training data becomes available, there inference models may be updated. However, at least some of the training data may be poisoned thereby tainting the updated inference model versions.

At operation 300, an inference model that is compromised is identified. The inference model may be identified by identifying that the inference model was obtained through, at least in part, an update using poisoned training data. The poisoned training data may be identified via any method (e.g., analysis of training data used to update inference models, by receiving notifications regarding poisoned training data, etc.).

The identification may be made using information regarding the training data upon which each inference model is based. Such information may be recorded as the inference models are updated over time.

At operation 302, a first resource cost for reverting the inference model to an uncompromised state and a second resource cost for reverting the inference model to a partially compromised state. The first resource costs may be identified by identifying all of the poisoned training data upon which the inference model is based and estimating a resource cost for performing untraining based on the poisoned training data. The second resource cost may be identified by identifying a portion of the poisoned training data upon which the inference model is based and estimating a resource cost for performing untraining based only on the portion of the poisoned training data.

The estimates may be obtained, for example, (i) using an empirical formula, (ii) using a fit function or inference model trained on historical quantities of resources expended for performing reversions based on different amounts of training data, (iii) using estimates provided by other entities, and/or via other methods.

Operation 302 may be repeated for any number of partial reversions using greater or lesser amounts of the poisoned training data.

At operation 304, a reversion plan for the inference model is obtained using a graphical user interface. The graphical user interface may be based at least in part on the first resource cost and the second resource cost for reverting the inference model.

The reversion plan may be obtained by allowing a user to explore different options for reversions that may be performed and select one of the options for reversion for performance. The reversion plan may be obtained using the method illustrated in FIG. 3B.

At operation 306, the reversion plan is performed to obtain an updated inference model. The reversion plan may be performed by, for example, untraining the model using a quantity of poisoned training data as specified in the reversion plan.

At operation 308, the updated inference model is used to provide computer implemented services. The computer implemented services may be provided by (i) initiating generation of inferences using the updated inference model, and (ii) using the generated inferences to provide, at least in part, the computer implemented services. The computer implemented services may ingest or otherwise use the generated inferences to perform various actions as part of the computer implemented services.

The method may end following operation 308.

Turning to FIG. 3B, a flow diagram illustrating a method of obtaining a reversion plan in accordance with an embodiment is shown. The method may be performed by any of client 100, model management system 102, and/or other components of the system shown in FIG. 1.

At operation 320, a range bar, a model indicator positioned with the range bar, a first recovery point indicator positioned with the range bar, and a second recovery point indicator positioned with the range bar are presented to a user. The presentation may be performed by adding the aforementioned graphical elements to a graphical user interface, and presenting the graphical user interface to a user. The graphical user interface may be similar to that discussed with respect to FIGS. 2B-2D.

At operation 322, information regarding reversion costs for reversion options are dynamically updated based on user input. For example, the reversion costs and other information may be dynamically updated as a user moves a reversion control between different locations along the range bar. The estimates may be based on the recovery point indicators nearest to the reversion control. In this manner, any number of indicators (e.g., 230-236) may be dynamically updated over time.

At operation 324, user input indicating a selection of the first recovery point indicator or the second recovery point indicator to define the reversion plan is obtained. The user input may indicate that a reversion based on the recovery point indicator nearest to the reversion control is to be performed. The reversion plan may be obtained by populating it with information based on the nearest recovery point indicator. For example, information regarding poisoned training data associated with the recovery point indicator may be added to the reversion plan.

For example, in FIG. 2B the reversion control as illustrated as being proximate to recovery point indicator 228E. At this location, reversion control may indicate that all of the poisoned training data to the right of reversion control 226 in the figure is to be used for untraining (e.g., all poisoned training data obtained after the previous version of the inference model associated with recovery point indicator 228E was obtained). Thus, this location may reflect that only a partial reversion is to be performed, and the resulting updated inference model may still have some influence of poisoned training data obtained prior to when the previous version of the inference model associated with recovery point indicator 228E was obtained.

The method may end following operation 324.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing inference models, the method comprising:
identifying an inference model of the inference models that is compromised;
identifying a first resource cost for reverting the inference model to an uncompromised state and second resource cost for reverting the inference model to a partially compromised state;
obtaining a reversion plan for the inference model using a graphical user interface based at least in part on the first resource cost and the second resource cost;
performing the reversion plan to obtain an updated inference model; and
using the updated inference model to provide computer implemented services.

2. The method of claim 1, wherein obtaining the reversion plan comprises:
presenting, to a user, the graphical user interface comprising:
a range bar,
a model indicator positioned with the range bar,
a first recovery point positioned with the range bar, and
a second recovery point positioned with the range bar; and
obtaining, from the user and to define the reversion plan, user input indicating a selection of the first recover point or the second recovery point.

3. The method of claim 2, wherein the first recovery point is based on a first previous version of the inference model in the uncompromised state, and the second recovery point is based on a second previous version of the inference model in the compromised state.

4. The method of claim 3, wherein the first recovery point and the second recovery point are positioned with the range bar based on a temporal ordering the first previous version of the inference model, the second previous version of the inference model, and the inference model.

5. The method of claim 4, wherein the second previous version of the inference model is a further trained version of the first previous of the inference model based on a first portion of poisoned training data.

6. The method of claim 5, wherein the inference model is a further trained version of the second previous of the inference model based on a second portion of poisoned training data.

7. The method of claim 6, wherein the graphical user interface further comprises:
a compromise indicator positioned with the range bar, the compromise indicator being based on the first portion of the poisoned training data and the second portion of the poisoned training data.

8. The method of claim 7, wherein the graphical user interface further comprises:
a reversion cost estimate indicator that indicates a computing resource cost for reverting the inference model to previous versions of the inference model based on the user input; and
a reversion time estimate indicator that indicates a duration of time for reverting the inference model to the previous versions of the inference model based on the user input.

9. A non-transitory machine-readable medium having instructions stored therein, which when executed by a processor, cause the processor to perform operations for managing for managing inference models, the operations comprising:
identifying an inference model of the inference models that is compromised;
identifying a first resource cost for reverting the inference model to an uncompromised state and second resource cost for reverting the inference model to a partially compromised state;
obtaining a reversion plan for the inference model using a graphical user interface based at least in part on the first resource cost and the second resource cost;
performing the reversion plan to obtain an updated inference model; and
using the updated inference model to provide computer implemented services.

10. The non-transitory machine-readable medium of claim 9, wherein obtaining the reversion plan comprises:
presenting, to a user, the graphical user interface comprising:
a range bar,
a model indicator positioned with the range bar,
a first recovery point positioned with the range bar, and
a second recovery point positioned with the range bar; and
obtaining, from the user and to define the reversion plan, user input indicating a selection of the first recover point or the second recovery point.

11. The non-transitory machine-readable medium of claim 10, wherein the first recovery point is based on a first previous version of the inference model in the uncompromised state, and the second recovery point is based on a second previous version of the inference model in the compromised state.

12. The non-transitory machine-readable medium of claim 11, wherein the first recovery point and the second recovery point are positioned with the range bar based on a temporal ordering the first previous version of the inference model, the second previous version of the inference model, and the inference model.

13. The non-transitory machine-readable medium of claim 12, wherein the second previous version of the inference model is a further trained version of the first previous of the inference model based on a first portion of poisoned training data.

14. The non-transitory machine-readable medium of claim 13, wherein the inference model is a further trained version of the second previous of the inference model based on a second portion of poisoned training data.

15. The non-transitory machine-readable medium of claim 14, wherein the graphical user interface further comprises:
a compromise indicator positioned with the range bar, the compromise indicator being based on the first portion of the poisoned training data and the second portion of the poisoned training data.

16. The non-transitory machine-readable medium of claim 15, wherein the graphical user interface further comprises:
a reversion cost estimate indicator that indicates a computing resource cost for reverting the inference model to previous versions of the inference model based on the user input; and
a reversion time estimate indicator that indicates a duration of time for reverting the inference model to the previous versions of the inference model based on the user input.

17. A data processing system, comprising:
a processor; and
a memory coupled to the processor to store instructions, which when executed by the processor, cause the processor to perform operations for managing data collection for managed devices and unmanaged devices, the operations comprising:
identifying an inference model of the inference models that is compromised;
identifying a first resource cost for reverting the inference model to an uncompromised state and second resource cost for reverting the inference model to a partially compromised state;
obtaining a reversion plan for the inference model using a graphical user interface based at least in part on the first resource cost and the second resource cost;
performing the reversion plan to obtain an updated inference model; and
using the updated inference model to provide computer implemented services.

18. The data processing system of claim 17, wherein obtaining the reversion plan comprises:
presenting, to a user, the graphical user interface comprising:
a range bar,
a model indicator positioned with the range bar,
a first recovery point positioned with the range bar, and
a second recovery point positioned with the range bar; and
obtaining, from the user and to define the reversion plan, user input indicating a selection of the first recover point or the second recovery point.

19. The data processing system of claim 18, wherein the first recovery point is based on a first previous version of the inference model in the uncompromised state, and the second recovery point is based on a second previous version of the inference model in the compromised state.

20. The data processing system of claim 19, wherein the first recovery point and the second recovery point are positioned with the range bar based on a temporal ordering the first previous version of the inference model, the second previous version of the inference model, and the inference model.
